(19) United States
(12) Patent Application Publication
(10) Pub. No.: US 2006/0158901 A1
(43) Pub. Date: Jul. 20, 2006

(54) Backlight module with combinative light source and device of changing color of illumination

(76) Inventor: Chih-Yuan Wang, Taichung Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/037,372

(22) Filed: Jan. 19, 2005

(51) Int. Cl. F21V 7/04

(52) U.S. Cl. 362/612

(57) ABSTRACT

A backlight module has a light guide member, a light source and a color-changing layer. The light guide member is made of a transparent substrate and has an output face, a guiding face opposite to the output face, an input face between the output face and the guiding face and a slot on the input face. The light source is mounted in the slot of the light guide member. The color-changing layer covers the light source to serve both functions of bonding the light source and changing the color of the illumination.

### BACKGROUND OF THE INVENTION

1. Field of the Invention

The present invention relates generally to a liquid crystal display, and more particularly to a backlight module, which the light guide member has a slot in which the light source is received and fixed to reduce the loss of illumination of the backlight module.

2. Description of the Related Art

As shown in FIG. 4, a conventional liquid crystal display (LCD) is consisted of a backlight module 8 and a liquid crystal panel 9. The backlight module 8 has a light guide plate 81 with an input face 811, a light source 82 facing the input face 811 of the light guide plate 81 and a reflector 83.

Wile the light source 82 emits light, a part of the light travels through the air between the light source 82 and the light guide member 81 and into the light guide member 81 via the input face 811. The other part of the light travels to the reflector 83 for reflection, and then travels into the light guide member 81 via the input face 811. However, the refractive index of the air approximates to 1 and the refractive index of the light guide member 81 is 1.5 to 1.6, so that the input face 811 will reflect a part of the light. That is a factor of decreasing the illuminance of the LCD.

If the liquid crystal panel 9 has a color film, which is a film with a predetermined color to change the color of the illumination, the color film will absorb and reflect a part of the light provided from the backlight module 8. That is another factor causing the reduction of the illuminance of the LCD. With these two factors that reduce the illuminance, the backlight module 8 does not have enough illuminance to provide to the liquid crystal panel 9.

### SUMMARY OF THE INVENTION

The primary objective of the present invention is to provide a backlight module, which the light guide member of which is provided with a slot and in which the light source is received to provide the light source emitting the light directly to the light guide member for reduction of the loss of illuminance.

The secondary objective of the present invention is to provide a backlight module, which the light source is surrounded with a color-changing layer to change the color of illumination.

The third objective of the present invention is to provide a backlight module, which the color-changing layer has a light-emitting material therein to change the color of illumination as well as to increase the illuminance.

The fourth objective of the present invention is to provide a backlight module, which the color-changing layer has a macromolecular adhesion to bond the light source in the slot.

According to the objectives of the present invention, a backlight module comprises a light guide member, which is made of a transparent substrate and has an output face, a guiding face opposite to the output face, an input face between the output face and the guiding face and a slot on the input face, and a light source mounted in the slot of the light guide member.

### BRIEF DESCRIPTION OF THE DRAWINGS

FIG. 1 is an exploded view of a preferred embodiment of the present invention;

FIG. 2 is a sectional view of the preferred embodiment of the present invention;

FIG. 3 is a sectional view of the preferred embodiment of the present invention, showing the light path, and

FIG. 4 a sectional view of the conventional LCD, showing the light path.

### DETAILED DESCRIPTION OF THE INVENTION

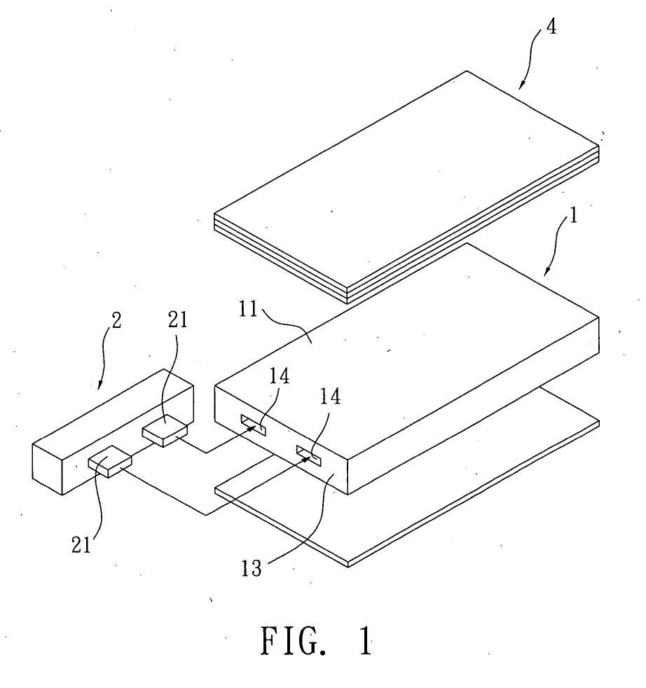

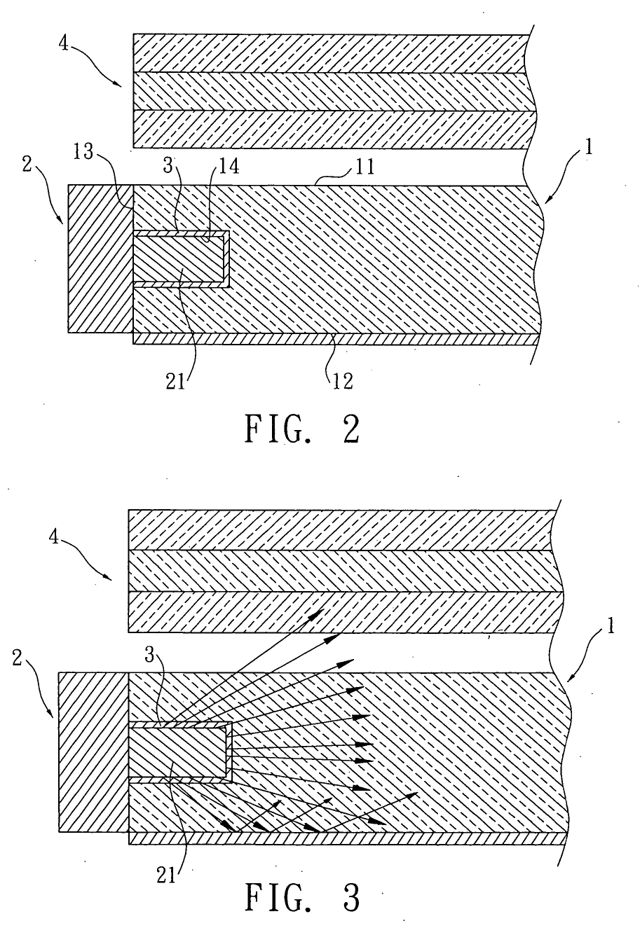

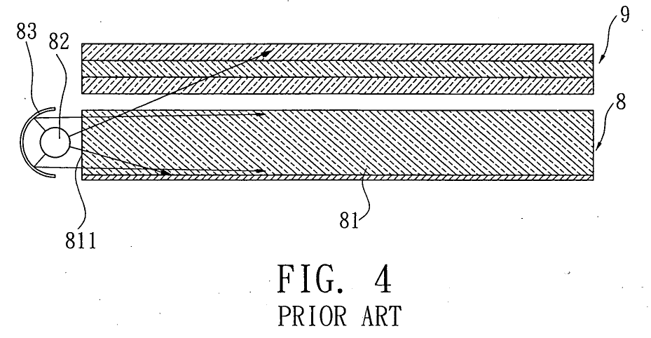

As shown in FIGS. from FIG. 1 to FIG. 3, a backlight module has a light guide member 1, a light source 2 and a color-changing layer 3 covering the light source 2. A liquid crystal panel 4 is mounted in front of the backlight module to assemble a liquid crystal display (LCD). The light source 2 has a plurality of packaged light-emitting diodes (LEDs) 21. The light guide member 1 is made of a transparent substrate and has an output face 11, a guiding face 12 opposite to the output face 11 and an input face 13 between the output face 11 and the guiding face 12. The light guide member 1 is provided with a plurality of slots 14 on the input face 13 in each of which an LED of the light source 2 is received.

The color-changing layer 3 is made of a mixture of a solid powder material and a macromolecular adhesion. The LEDs 21 are fixed in the slots 14 by the macromolecular adhesion of the color-changing layer 3. The solid powder material is consisted of a light-emitting material and a diffusive powder. The light-emitting material has a predetermined color to change the color of the illumination. The diffusive powder is made of a material chosen from acrylic powder, TiO₂, SiO₂ and BaTiO₃ and the concentration thereof is in a range of 10% to 50% by weight.

The macromolecular adhesion made of a material chosen from epoxy resin, polyamide resin, acrylic resin, polyester resin, polyether resin, halogen-containing rubber, rubber, silicone-containing resin and cellulose resin and the concentration thereof is in a range of 20% to 90% by weight.

The light source also can be two unpackaged LEDs (not shown). The LEDs are embedded in the slots of the light guide member and then are packaged. This light source serves the same function as described above.

The functions of the present invention are:
1. The light guide member 1 is provided with the slots 14 on the input face 13 to bond the light source 2 therein. The light provided from the light source 2 travels into the light guide member 1 directly to reduce the loss of the illumination and to increase the illuminance.
2. The light source 2 is covered with the color-changing layer 3 to change the color of the light into a predetermined color.
3. The color-changing layer 3 has the light-emitting material therein to increase the illuminance in the process of changing color.
4. The color-changing layer 3 has the macromolecular adhesion to serve the media of bonding the light source in the slots 14 of the light guide member 1.

What is claimed is:

1. A backlight module, comprising a light guide member, which is made of a transparent substrate and has an output face, a guiding face opposite to the output face, an input face between the output face and the guiding face and a slot on the input face, and a light source mounted in the slot of the light guide member.

2. The backlight module as defined in claim 1, wherein the light source has a packaged light-emitting diode.

3. The backlight module as defined in claim 1, wherein the light source has a unpackaged light-emitting diode and the light-emitting diode is received in the slot of the light guide member and packaged.

4. A backlight module, comprising a light guide member, which is made of a transparent substrate and has an output face, a guiding face opposite to the output face, an input face between the output face and the guiding face and a slot on the input face; a light source mounted in the slot of the light guide member, and a color-changing layer covering the light source, wherein the color-changing layer has a solid powder material and a macromolecular adhesion and the solid powder material has a predetermined color to change the color of the light provided from the light source.

5. The backlight module as defined in claim 4, wherein the solid powder material of the color-changing layer has a mixture of a light-emitting material and a diffusive material and the light-emitting material has the predetermined color.

6. The backlight module as defined in claim 4, wherein the macromolecular adhesion of the color-changing layer is made of a material chosen from epoxy resin, polyamide resin, acrylic resin, polyester resin, polyether resin, halogen-containing rubber, rubber, silicone-containing resin and cellulose resin and a concentration thereof is in a range of 20% to 90% by weight.

7. The backlight module as defined in claim 4, wherein the macromolecular adhesion of the color-changing layer bonds the light source in the slot of the light guide member.

8. The backlight module as defined in claim 4, wherein the light source has a packaged light-emitting diode.

9. The backlight module as defined in claim 4, wherein the light source has a unpackaged light-emitting diode and the light-emitting diode is received in the slot of the light guide member and packaged.

10. The backlight module as defined in claim 5, wherein the diffusive powder is made of a material chosen from acrylic powder, TiO₂, SiO₂ and BaTiO₃ and a concentration thereof is in a range of 10% to 50% by weight.
